(19) United States
(12) Patent Application Publication
(10) Pub. No.: US 2014/0010159 A1
(43) Pub. Date: Jan. 9, 2014

(54) MULTI-STREAM JOINT TRANSMISSION SCHEME FOR WIRELESS COMMUNICATION NETWORK

(71) Applicants: Alexei Vladimirovich Davydov, Nizhny Novgorod (RU); Alexander Alexandrovich Maltsev, Nizhny Novgorod (RU); Gregory Vladimirovich Morozov, Nizhny Novgorod (RU); Ilya Alexandrovich Bolotin, Nizhny Novgorod (RU); Vadim Sergeyevich Sergeyev, Nizhny Novgorod (RU)

(72) Inventors: Alexei Vladimirovich Davydov, Nizhny Novgorod (RU); Alexander Alexandrovich Maltsev, Nizhny Novgorod (RU); Gregory Vladimirovich Morozov, Nizhny Novgorod (RU); Ilya Alexandrovich Bolotin, Nizhny Novgorod (RU); Vadim Sergeyevich Sergeyev, Nizhny Novgorod (RU)

(21) Appl. No.: 13/994,050

(22) PCT Filed: Sep. 30, 2011
(86) PCT No.: PCT/RU2011/000749

§ 371 Date: Sep. 23, 2013

Related U.S. Application Data
(60) Provisional application No. 61/471,042, filed on Apr. 1, 2011.

(51) Int. Cl. H04W 24/10

(52) U.S. Cl. CPC H04W 24/10
USPC 370/328

(57) ABSTRACT

Embodiments herein provide a wireless communication system including a user equipment (UE) and a plurality of base stations (e.g., evolved NodeBs (eNBs)). The UE may generate feedback information based on channel conditions between the UE and two or more of the plurality of base stations. The UE may transmit the feedback information to one or more of the base stations. Two or more of the plurality of base stations may contemporaneously send different data streams to the UE, the data streams having properties based at least in part on the respective feedback information. The UE may decouple and decode the data streams from the two or more base stations using multi-antenna techniques.

### CROSS REFERENCE TO RELATED APPLICATION

The present application claims priority to U.S. Patent Application No. 61/471,042, titled “Advanced Wireless Communication Systems And Techniques,” filed Apr. 1, 2011, the entire specification of which is hereby incorporated by reference in its entirety for all purposes.

### TECHNICAL FIELD

Embodiments of the present disclosure relate generally to wireless communication systems, and more particularly, to multi-stream joint transmission schemes for wireless communication networks.

### BACKGROUND

Wireless communication networks may include a plurality of base stations (e.g., evolved NodeBs (eNBs)) in a cell. For example, a cell may be covered by a higher power base station (e.g., macro eNB) and one or more lower power base stations (e.g., pico eNBs or femto eNBs). A user equipment (UE) in the cell may communicate with any of the base stations in the cell. However, when the UE is communicating with a first base station in the cell, the UE may receive interference from a second base station in the cell (or in a neighboring cell).

One way to combat the interference is to reduce power of, or completely stop, transmissions from the second base station on certain channel resource blocks. However, this degrades performance of the second base station by wasting channel resources. Another way is to have the first base station and second base station cooperatively send the same signal to the UE. The cooperative transmission may improve signal power at the UE. However, precise synchronization and/or co-phasing of the signals transmitted by the cooperating base stations are required, which substantially complicates the system. Additionally, the co-phasing consumes extra channel resources, and the overall system throughput is reduced since the cooperating base stations are transmitting the same information.

### BRIEF DESCRIPTION OF THE DRAWINGS

Embodiments of the present disclosure will be described by way of exemplary embodiments, but not limitations, illustrated in the accompanying drawings in which like references denote similar elements, and in which:

FIG. 1 schematically illustrates a wireless communication network in accordance with various embodiments.

FIG. 2 illustrates a first data stream and a second data stream in accordance with various embodiments.

FIG. 3 illustrates a flow diagram of a multi-stream joint transmission scheme from the perspective of a user equipment, in accordance with various embodiments.

FIG. 4 illustrates an information flow scheme among network components in accordance with various embodiments.

FIG. 5 illustrates an example of beamforming between a user equipment and first and second base stations, in accordance with various embodiments.

FIG. 6 schematically illustrates a wireless communication network in accordance with various embodiments.

FIG. 7 schematically illustrates a user equipment in accordance with various embodiments.

FIG. 8 schematically illustrates a base station in accordance with various embodiments.

### DETAILED DESCRIPTION

Illustrative embodiments of the present disclosure include, but are not limited to, methods and apparatuses for flexible rank adaptation in a wireless communication network.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in some embodiments” is used repeatedly. The phrase generally does not refer to the same embodiments; however, it may. The terms “comprising,” “having,” and “including” are synonymous, unless the context dictates otherwise. The phrase “A and/or B” means (A), (B), or (A and B). The phrase “NB” means (A), (B), or (A and B), similar to the phrase “A and/or B”. The phrase “at least one of A, B and C” means (A), (B), (C), (A and B), (A and C), (B and C) or (A, B and C). The phrase “(A) B” means (B) or (A and B), that is, A is optional.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims and the equivalents thereof.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Embodiments of the present disclosure may be used in wireless communication networks that employ orthogonal frequency division multiple access (OFDMA) communications as used by multicarrier transmission schemes presented in, e.g., the Institute of Electrical and Electronics Engineers (IEEE) 802.16—2009, approved May 13, 2009, along with any amendments, updates, and/or revisions, 3rd Generation Partnership Project (3GPP) long-term evolution (LTE) project, advanced LTE project, ultra mobile broadband (UMB) project (also referred to as “3GPP2”), etc. In other embodiments, communications may be compatible with additional/alternative communication standards and/or specifications.

In various embodiments, the wireless communication network may be Internet Protocol (IP) based. For example, a user equipment (UE) may exchange authentication information with, and receive an IP address from, the IP-based wireless communication network for communication within the network. The UE may be in a connected state after receiving the IP address.

In some embodiments, a method of the present disclosure includes generating, by a user equipment (UE) having a plurality of antennas, first feedback information based on channel conditions of a first channel between the UE and a first evolved NodeB (eNB) of an Internet Protocol (IP) based wireless communication network; generating, by the UE, second feedback information based on channel conditions of a second channel between the UE and a second eNB of the IP-based wireless communication network; transmitting, by the UE to the first eNB, the first feedback information; transmitting, by the UE, the second feedback information to at least one of the first eNB and/or the second eNB; receiving, by the UE, a first data stream from the first eNB via the first channel; and receiving, by the UE, contemporaneously with the receiving of the first data stream, a second data stream from the second eNB via the second channel, the second data stream being different from the first data stream.

In some embodiments of the method, the first feedback information includes a transmission rank, a precoding matrix index (PMI), and/or a modulation and coding scheme (MCS) for the first eNB to use when communicating with the UE. In some embodiments, the transmission rank is a first transmission rank, the PMI is a first PMI, the MCS is a first MCS, and the second feedback information includes a second transmission rank, a second PMI, and/or a second MCS for the second eNB to use when communicating with the UE.

In some embodiments of the method, the first data stream has a first spatial signature based on the first PMI and the second data stream has a second spatial signature based on the second PMI, and the receiving of the first data stream includes decoupling the first data stream from the second data stream, using the plurality of antennas, and decoding the first data stream, and the receiving of the second data stream includes decoupling the second data stream from the first data stream, using the plurality of antennas, and decoding the second data stream.

In some embodiments of the method, the first data stream includes a first orthogonal frequency division multiplexing (OFDM) symbol and a guard interval; the second data stream includes a second OFDM symbol, and the receiving of the second data stream includes starting to receive the second OFDM symbol within the guard interval.

In some embodiments, the first channel and the second channel each include one or more resource blocks, and the first data stream and the second data stream are received via one or more common resource blocks.

In some embodiments, the first feedback information includes a transmission rank having a value of two or greater, and the method further includes receiving, by the UE contemporaneously with the receiving of the first data stream, a third data stream from the first eNB, the third data stream being different from the first data stream and the second data stream.

In some embodiments, the method further includes generating, by the UE, third feedback information based on channel conditions of a third channel between the UE and a third eNB of the IP-based wireless communication network; transmitting, by the UE, the third feedback information to at least one of the first eNB and/or the third eNB; and receiving, by the UE contemporaneously with the receiving of the first data stream and the second data stream, a third data stream from a third eNB, the third data stream being different from the first data stream and the second data stream.

In some embodiments of the method, the first eNB and the second eNB are both associated with a cell of the IP-based wireless communication network, and the first eNB has a higher transmission power than the second eNB.

Some embodiments of the present disclosure may include a user equipment (UE) including a plurality of antennas; a channel estimation module coupled to the plurality of antennas and configured to determine first feedback information based on channel conditions of a first channel between the UE and a first evolved NodeB (eNB) and second feedback information based on channel conditions of a second channel between the UE and a second eNB, the first feedback information and second feedback information configured to be used by the first eNB and second eNB, respectively, for transmissions to the UE on one or more common resource blocks; and a transmitter module coupled to the channel estimation module and configured to transmit the first feedback information to the first eNB and to transmit the second feedback information to at least one of the first eNB and/or the second eNB.

In some embodiments of the UE, the transmitter module is configured to transmit the first feedback information and the second feedback information to the first eNB. In some embodiments of the UE, the transmitter module is configured to transmit the second feedback information to the second eNB.

In some embodiments, the UE further includes a receiver module coupled to the plurality of antennas and configured to contemporaneously receive a first data stream, including a first orthogonal frequency division multiplexing (OFDM) symbol and a guard interval, from the first eNB, and a second data stream, including a second OFDM symbol and the guard interval, from the second eNB, wherein the second data stream is different from the first data stream and a time difference between when the receiver module starts to receive the first OFDM symbol and when the receiver module starts to receive the second OFDM symbol is less than a time period of the guard interval.

In some embodiments of the UE, the first feedback information includes a first precoding matrix index (PMI) and the second feedback information includes a second PMI, and the first data stream has a first spatial signature based on the first PMI and the second data stream has a second spatial signature based on the second PMI.

In some embodiments of the UE, the receiver module is further configured to decouple the first data stream from the second data stream, using the plurality of antennas, based on the first spatial signature and the second spatial signature.

In some embodiments of the UE, the first feedback information includes a transmission rank indicator having a value of two or greater, and the receiver module is further configured to receive, contemporaneously with receiving the first data stream, a third data stream from the first eNB, the third data stream being different from the first data stream and the second data stream.

In some embodiments of the UE, the channel estimation module is further configured to determine third feedback information based on channel conditions of a third channel between the UE and a third eNB, the transmitter module is further configured to transmit the third feedback information to at least one of the first eNB, the second eNB, and/or the third eNB, and the receiver module is further configured to receive a third data stream from the third eNB on one or more of the common resource blocks.

Some embodiments of the present disclosure may include an evolved NodeB (eNB) including a processor configured to establish a first wireless communication link between the eNB and a user equipment (UE) over a channel; a receiver module coupled to the processor and configured to receive feedback information related to the channel with respect to wireless communication links between the UE and two or more eNBs, the feedback information including one or more first feedback indicators associated with the first wireless communication link and one or more second feedback indicators associated with a second wireless communication link between the UE and another eNB over the channel; and a transmitter module coupled to the processor and configured to transmit the one or more second feedback indicators to the other eNB.

In some embodiments of the eNB, the one or more first feedback indicators include a first transmission rank, a first precoding matrix index (PMI) and/or a first modulation and coding scheme (MCS) for the eNB to use when communicating with the UE, and the one or more second feedback indicators include a second transmission rank, a second PMI, and/or a second MCS for the other eNB to use when communicating with the UE.

In some embodiments of the eNB, the transmitter module is further configured to transmit, via the first wireless communication link, a first data stream having properties based at least in part on the one or more first feedback indicators, the first data stream being different from a second data stream transmitted by the other eNB to the UE contemporaneously with the transmitting of the first data stream by the eNB.

In some embodiments of the eNB, the first data stream includes a first orthogonal frequency division multiplexing (OFDM) symbol and the second data stream includes a second OFDM symbol and a guard interval, and wherein the transmitter module is further configured to transmit the first OFDM symbol to the UE so that the first OFDM symbol arrives at the UE during the guard interval of the second data stream.

In some embodiments of the eNB, the one or more first feedback indicators include a transmission rank having a value of two or greater, and the transmitter module is further configured to transmit, contemporaneously with transmitting the first data stream, a third data stream to the UE, the third data stream being different from the first data stream and the second data stream.

In some embodiments of the eNB, the UE comprises a first UE, and the transmitter module is further configured to transmit a multi-user multiple input multiple output (MU-MIMO) transmission over the channel, the MU-MIMO transmission including the first data stream configured to be received by the first UE and a third data stream configured to be received by a second UE.

Some embodiments of the present disclosure may include an evolved NodeB (eNB) including a processor configured to establish a wireless communication link with a user equipment (UE) over a channel; and a transmitter module coupled to the processor and configured to send a first data stream to the UE, the first data stream including a first orthogonal frequency division multiplexing (OFDM) symbol and a guard interval, the transmitter further configured to transmit the first data stream so that a time difference between when the UE starts to receive the first OFDM symbol and when the UE starts to receive a second OFDM symbol sent from another eNB is less than a time period of the guard interval.

In some embodiments, the eNB further includes a receiver module coupled to the processor and configured to receive, from the UE via the communication link, first feedback information based on channel conditions between the UE and the eNB and second feedback information based on channel conditions between the UE and the other eNB, and the transmitter module is further configured to send the second feedback information to the other eNB.

In some embodiments of the eNB, the first feedback information includes a first transmission rank, a first precoding matrix index (PMI) and/or a first modulation and coding scheme (MCS) for the eNB to use when communicating with the UE, and the second feedback information includes a second transmission rank, a second PMI, and/or a second MCS for the other eNB to use when communicating with the UE.

In some embodiments of the eNB, the first feedback information includes the first PMI and the second feedback information includes the second PMI, and the first data stream has a first spatial signature based on the first PMI and the second data stream has a second spatial signature based on the second PMI, the first spatial signature being different than the first spatial signature.

In some embodiments of the eNB, the first feedback information includes a transmission rank having a value of two or greater, and the transmitter module is further configured to send a third data stream to the UE contemporaneously with sending the first data stream, the third data stream being different from the first data stream and the second data stream.

In some embodiments of the eNB, the UE comprises a first UE, and the transmitter is further configured to transmit a multi-user multiple input multiple output (MU-MIMO) transmission over the channel, the MU-MIMO transmission including the first data stream configured to be received by the first UE and a third data stream configured to be received by a second UE.

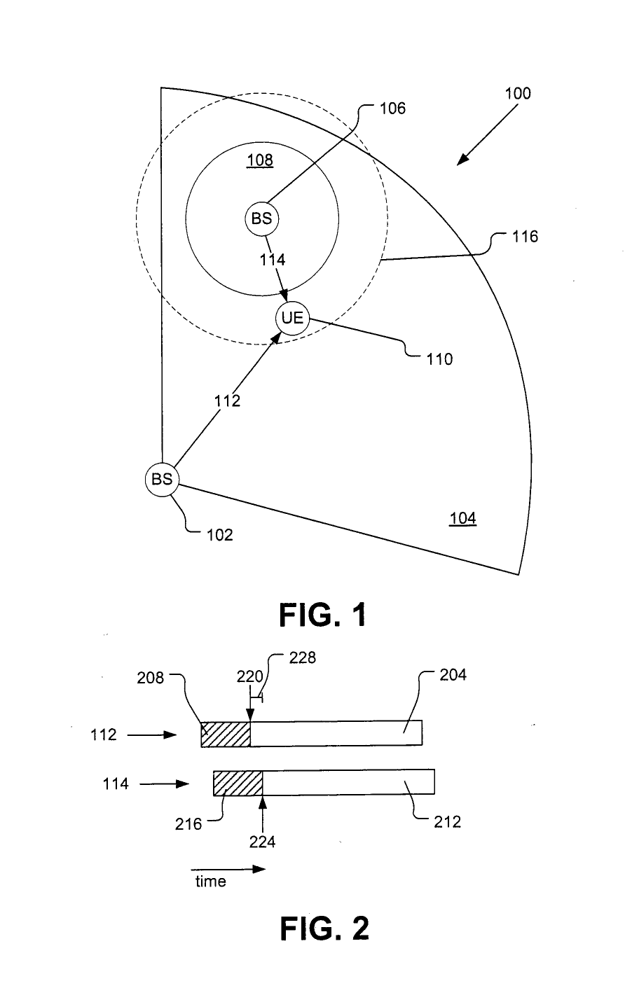

Various embodiments provide a multi-stream joint transmission scheme for a wireless communication network. FIG. 1 schematically illustrates a wireless communication network 100, in accordance with various embodiments. Wireless communication network 100 may include a first base station 102 configured to communicate with one or more UEs within a first range 104. The wireless communication network 100 may further include a second base station 106 configured to communicate with one or more UEs within a second range 108. First base station 102 and second base station 106 may be any appropriate type of evolved NodeB (also referred to as an eNodeB or eNB) and/or any other appropriate type of base station configured to wirelessly communicate with one or more UEs over a wireless communication channel using any appropriate wireless transmission protocol. In some embodiments, as shown in FIG. 1, second base station 106 may have a lower transmission power than first base station 102. For example, first base station 102 may be a macro eNB, and second base station 106 may be a pico eNB or femto eNB. In these embodiments, the second range 108 may be at least partially within the first range 104.

In various embodiments, the wireless communication network 100 may further include a UE 110 configured to communicate with one or more base stations over a wireless communication channel. In various embodiments, the UE 110 may include at least two antennas to decouple and decode signals coming from two or more base stations. In various embodiments, the UE 110 may be any device capable of wirelessly communicating with one or more base stations over a wireless communication channel using any appropriate wireless transmission protocol. The UE 110 may be, for example, a mobile station, a cellular or mobile phone, a personal computer (PC), a tablet computer, an e-reader, a personal digital assistant (PDA), a pager, and/or another consumer electronics device such as an mp3 player.

In various embodiments, the UE 110 may contemporaneously receive a first data stream 112 from the first base station 102 over a first channel and a second data stream 114 from the second base station 106 over a second channel. In various embodiments, the second data stream 114 may be different from the first data stream 112 (i.e., include different data). The UE 110 may decouple the first data stream 112 from the second data stream 114 using multiple antenna techniques, and independently decode the first data stream 112 and second data stream 114.

In various embodiments, the first channel and the second channel may each utilize one or more resource blocks for communications over the channel. For example, the resource blocks may include one or more frequency blocks (e.g., a frequency range, a carrier frequency, and/or a sub-carrier frequency) and/or time domain blocks (e.g., time division slots). In some embodiments, the first channel and the second channel may use one or more of the same resource blocks. In these embodiments, the first channel and second channel may also be referred to as being the same channel. The UE may have separate wireless communication links (i.e., first and second wireless communication links, respectively) with the first base station and second base station over the channel. The first and second wireless communication links may utilize one or more of the same resource blocks of the channel.

Accordingly, the multi-stream transmission scheme described herein may provide increased throughput by allowing multiple base stations to contemporaneously transmit different information to the UE using the same resource blocks of the channel.

Additionally, the multi-stream transmission scheme may extend the useful range of the lower power base station (e.g., second base station 106). Ordinarily, second base station 106 may not communicate with UE 110 when UE 110 is outside of the second range 108, because the interference from the first base station 112 becomes too great.

In the multi-stream wireless communication scheme described herein, the first base station 102 and second base station 106 transmit different data streams to the UE 110. The UE 110 may decouple the transmissions from the first base station 102 and second base station 106 using multiple antenna techniques. The multi-stream wireless communication scheme may allow the lower power base station (e.g., second base station 106) to communicate with UE 110, even when UE 110 is outside the second range 108, without degrading the performance of the higher power base station (e.g., first base station 102) and/or wasting channel resources. As shown in FIG. 1, UE 110 may be within an extended range 116 of second base station 106.

Although the first base station 102 is shown in FIG. 1 to have a higher transmission power than the second base station 104, in other embodiments, the first base station 102 may have any suitable transmission power in comparison with the second base station 104, such as the same, higher, and/or lower transmission power.

In various embodiments, the wireless communication network 100 may utilize a communication protocol based on orthogonal frequency division multiplexing (OFDM). As shown in FIG. 2, the first data stream 112 may include a first OFDM symbol 204 and a first guard interval 208. The second data stream 114 may include a second OFDM symbol 212 and a second guard interval 216. The first guard interval 208 and/or second guard interval 216 may include a cyclic prefix. The first guard interval 208 of the first data stream 204 may be the same duration, longer than, and/or shorter than the second guard interval 216 of the second data stream 212. The UE 110 may start to receive the first OFDM symbol 204 at a first start time 220, and may start to receive the second OFDM symbol 212 at a second start time 224.

In various embodiments, the transmissions of the first base station 102 and/or the second base station 106 may be timed so that a time difference 228 between the first start time 220 and the second start time 224 is less than a time period of the guard interval. For example, the BS 106 may transmit the second OFDM symbol 212 so that the UE 110 may start to receive first OFDM symbol 204 while receiving the second guard interval 216 (as shown in FIG. 2). Alternatively, the BS 106 may transmit the second OFDM symbol 212 so that the UE 110 may start to receive the second OFDM symbol 212 while it is receiving first guard interval 208.

The first base station 102 and second base station 106 may use a common synchronization signal (e.g., the Global Positioning System (GPS) synchronization signal) to facilitate timing of the first data stream 112 with the second data stream 114. Alternatively, or additionally, the first base station 102 may communicate timing information to the second base station 106, and/or the UE 110 may communicate timing information to the first base station 102 and/or the second base station 106. An OFDM-based communication protocol may allow a relatively long guard interval. Accordingly, it may be unnecessary for the first base station 102 and second base station 106 to employ precise phase synchronization between their respective transmissions, as would be necessary if the first base station 102 and second base station 106 were cooperatively sending the same data stream.

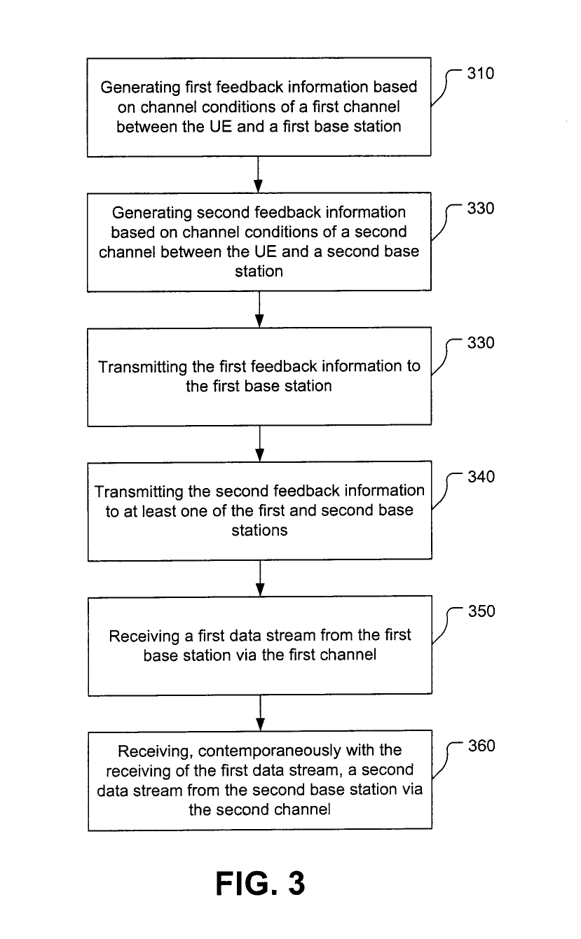

Various embodiments may provide a feedback protocol to support the multi-stream transmission scheme. FIG. 3 illustrates a flow diagram of an embodiment of the multi-stream transmission scheme from the perspective of the UE 110. In various embodiments, at 310, the UE 110 may generate first feedback information based on channel conditions of the first channel between the UE 110 and the first base station 102. The UE 110 may also generate, at 320, second feedback information based on channel conditions of the second channel between the UE 110 and the second base station 106. The first feedback information and second feedback information may be configured to be used by the first base station 102 or second base station 106, respectively, for transmissions to the UE 110 using one or more common resource blocks. The UE 110 may then transmit, at 330, the first feedback information to the first base station 102. At 340, the UE 110 may transmit the second feedback information to at least one of the first base station 102 and/or the second base station 106.

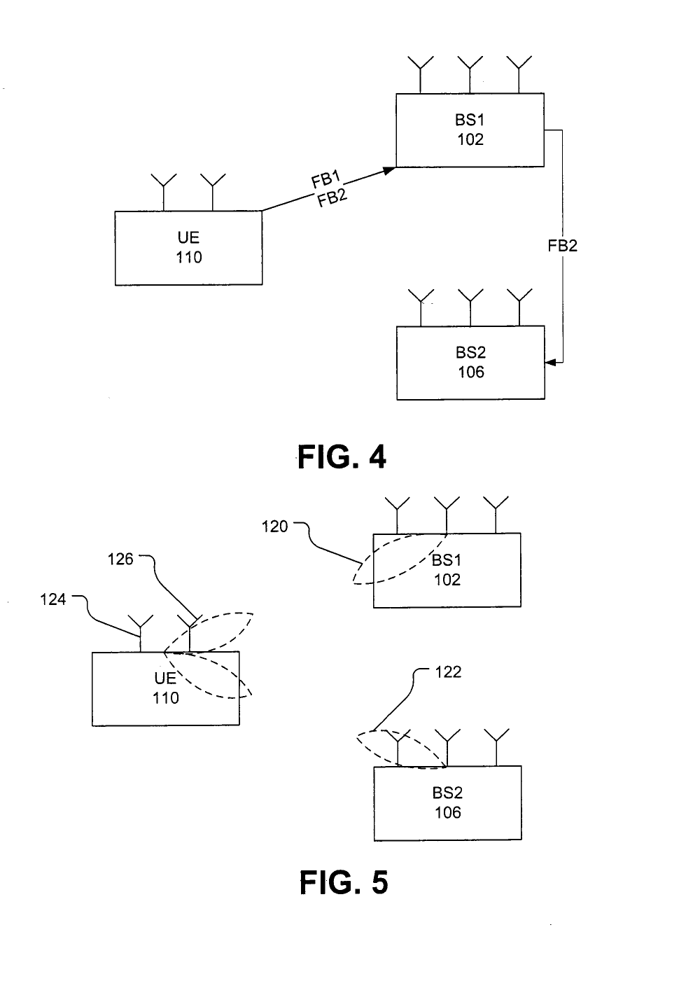

In some embodiments, the UE 110 may transmit both the first feedback information and the second feedback information to the base station with which the UE 110 is currently associated. For example, as shown in FIG. 4, the UE 110 may transmit the first feedback information (FB1) and the second feedback information (FB2) to the first base station 102. The first base station 102 may receive the first feedback information and the second feedback information, and may transmit the second feedback information to the second base station 106. The first base station 102 may then transmit the first data stream 112 with transmission properties based at least in part on the first feedback information, and the second base station 106 may transmit the second data stream 114 with transmission properties based at least in part on the second feedback information.

In other embodiments, the UE 110 may transmit the first feedback information to the first base station 102 and may transmit the second feedback information to the second base station 106.

Referring again to FIG. 3 and as described above, after the UE 110 transmits the first and second feedback information, the UE 110 may, at 350, receive a first data stream from the first base station via the first channel, and, at 360, contemporaneously receive a second data stream from the second base station via the second channel.

In various embodiments, the feedback information may include one or more feedback indicators, such as a transmission rank indicator, a channel quality indicator (CQI), a precoding matrix index (PMI), and/or one or more modulation and coding schemes (MCSs) for a base station to use when communicating with the UE. In embodiments in which the feedback information includes the PMI, the PMI may be used by a base station to attach a spatial signature to the transmission, such as by applying a beamforming vector. In embodiments in which the feedback information includes a transmission rank indicator of two or more, the feedback information may include an MCS for each spatial stream of the transmission rank (e.g., three MCSs for a transmission rank of three).

FIG. 5 illustrates an example of beamforming in the multi-stream joint transmission scheme. BS1 102 may transmit the first data stream 112 with a first spatial signature 120 based on a first PMI of the first feedback information. Similarly, BS2 106 may transmit the second data stream 114 with a second spatial signature 122 based on a second PMI of the second feedback information. The UE 110 may include a plurality of antennas including a first antenna 124 and a second antenna 126. The UE 110 may decouple the first data stream 112 and the second data stream 114, using the first antenna 124 and the second antenna 126, based on the first spatial signature 120 and the second spatial signature 122.

In some embodiments, the first PMI and second PMI may be selected to facilitate decoupling of the first data stream 112 and the second data stream 114 by the UE 110. Alternatively, or additionally, one or more of the base stations (e.g., first base station 102 and/or second base station 106) may apply beamforming vectors to their respective transmissions to maximize the aggregate throughput of the wireless communication network 100 as a whole.

In some embodiments, the first feedback information and/or the second feedback information may include a transmission rank indicator of two or greater. Accordingly, the first base station 102 and/or the second base station 106 may send transmissions to the UE 110 having a transmission rank of two or greater (e.g., a MIMO signal). For example, the first base station 102 may transmit a third data stream to the UE 110 contemporaneously with sending the first data stream 112 to the UE 110. The UE 110 may have at least as many antennas as a number of simultaneous data streams received by the UE 110.

In some embodiments, more than two base stations may cooperate to send different data streams to the UE 110. For example, the UE 110 may receive a third data stream from a third base station, the third data stream being different from the first data stream 112 and the second data stream 114. The third data stream may be received by the UE 110 contemporaneously with the first data stream 112 and the second data stream 114.

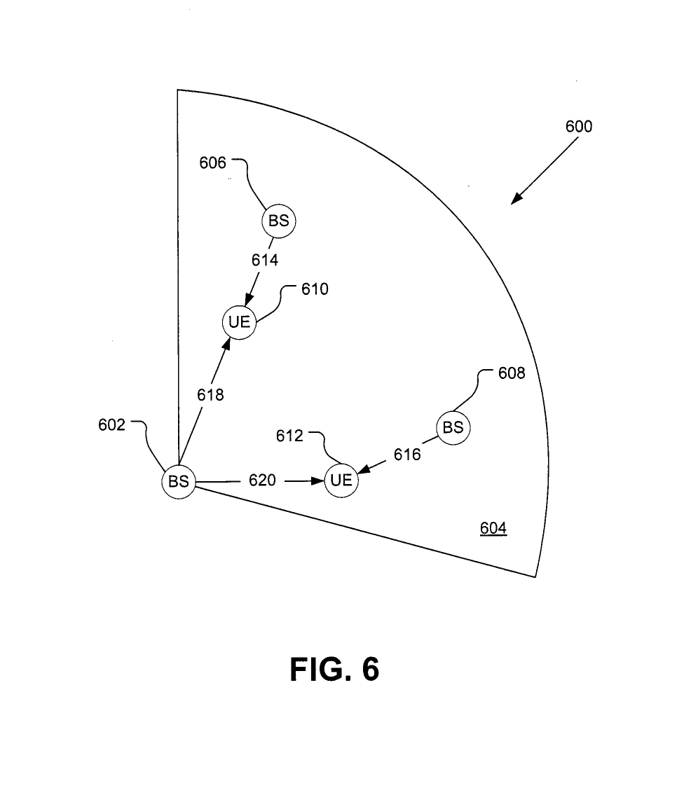

FIG. 6 shows another embodiment of a wireless communication network 600 employing the multi-stream joint transmission scheme. Wireless communication network 600 may include a first base station 602 that is capable of sending multi-user MIMO (MU-MIMO) transmissions within a cell 604. First base station 602 may be a high power base station, such as a macro eNB. Wireless communication network 600 may further include a plurality of lower power base stations (e.g., pico eNBs and/or femto eNBs), including a second base station 606 and a third base station 608. In other embodiments, second base station 606 and/or third base station may have the same or greater transmission power as first base station 602.

Wireless communication network 600 may further include a first UE (UE1) 610 and a second UE (UE2) 612. UE1 610 may receive a first data stream 614 from the second base station 606, and UE2 612 may receive a second data stream 616 from the third base station 608. Additionally, the first base station 602 may send a MU-MIMO stream, including a third data stream 618 intended for UE1 610 and a fourth data stream 620 intended for UE2 612. The first base station 602 may attach a different spatial signature to the third data stream 618 than to the fourth data stream 620 so that the intended data stream may be decoupled by the respective UE. The first data stream 614, second data stream 616, third data stream 618, and fourth data stream 620 may all be different from one another. Accordingly, this approach may further increase the aggregate throughput in the wireless communication network 600. The MU-MIMO transmission may be particularly effective if the UE1 610 and UE2 612 are in relatively different directions from first base station 602 within cell 604, thereby allowing the beamforming to sufficiently separate in space the third data stream 618 from the fourth data stream 620.

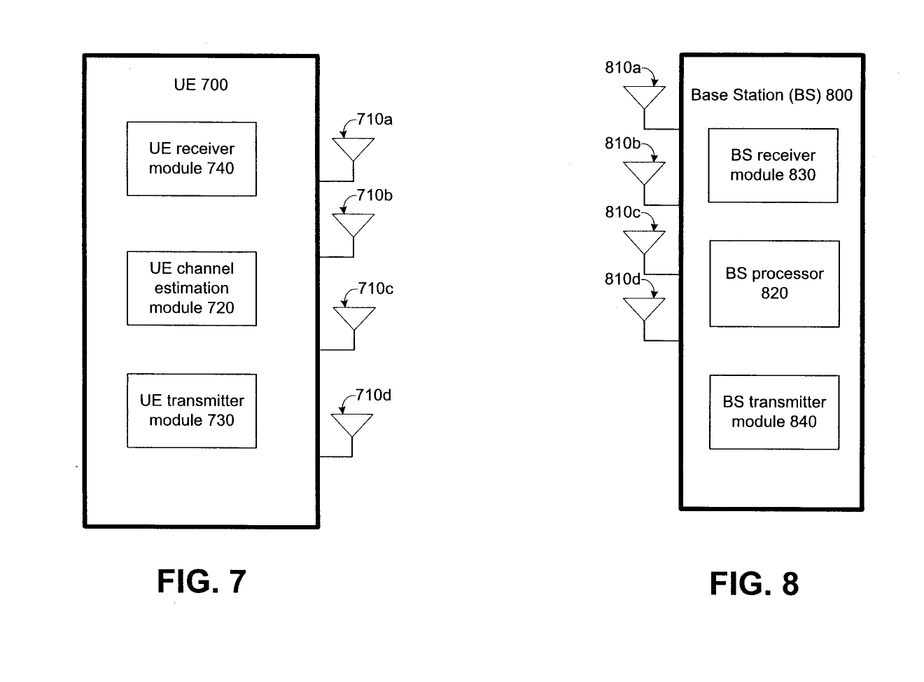

FIG. 7 schematically illustrates a UE 700, in accordance with various embodiments. In various embodiments, UE 700 may be equivalent to UE 110 as depicted in FIGS. 1, 4, and 5, and/or UE1 610 and/or UE2 612 as depicted in FIG. 6. As shown in FIG. 7, in various embodiments, a UE 700 may include a plurality of antennas, e.g., antennas 710a-d, configured to receive signals transmitted from one or more base stations. In FIG. 7, four antennas are illustrated, although in various other embodiments, any other suitable number of antennas may be included in the UE 700. In various embodiments, the UE 700 may include at least as many antennas as a number of one or more data streams received by the UE 700 from the one or more base stations, although the scope of the present disclosure may not be limited in this respect. One or more of the antennas 710a-d may be alternately used as transmit or receive antennas. Alternatively, or additionally, one or more of the antennas 710a-d may be dedicated receive antennas or dedicated transmit antennas.

In various embodiments, UE 700 may further include a channel estimation module 720 coupled to one or more of the antennas 710a-d. The channel estimation module 720 may determine feedback information based on channel conditions between the UE 700 and two or more base stations. For example, the channel estimation module 720 may determine first feedback information based on channel conditions of a first channel between the UE 700 and a first base station and second feedback information based on channel conditions of a second channel between the UE and a second base station. The first feedback information may include a first transmission rank indicator, a first CQI, a first PMI, and/or a first MCS for the first base station to use when communicating with the UE 700. Similarly, the second feedback information may include a second rank indicator, a second CQI, a second PMI, and/or a second MCS for the second base station to use when communicating with the UE 700.

In various embodiments, the UE 700 may further include a transmitter module 730 coupled to the channel estimation module 720. In some embodiments, the transmitter module 730 may transmit both the first feedback information and the second feedback information to the first base station. In other embodiments, the transmitter module 730 may transmit the first feedback information to the first base station, and may transmit the second feedback information to the second base station.

In various embodiments, the UE 700 may further include a receiver module 740 coupled to one or more of the plurality of antennas 710a-d. The receiver module 740 may contemporaneously receive a first data stream from the first base station and a second data stream from the second base station. The first data stream may include first OFDM symbols separated by guard intervals, and the second data stream may include second OFDM symbols separated by guard intervals. The receiver module 740 of UE 700 may start to receive the second OFDM symbols within a time period of the guard interval from starting to receive the first OFDM symbols.

In some embodiments, the receiver module 740 may receive the first data stream and the second data stream on one or more common resource blocks. The common resource blocks may include one or more frequency blocks (e.g., a frequency range, a carrier frequency, and/or a sub-carrier frequency) and/or time domain blocks (e.g., time division slots) shared by the first channel and second channel.

In various embodiments, the receiver module 740 may decouple and decode the first data stream and the second data stream using two or more of the plurality of antennas 710a-d. In some embodiments, the first data stream may have a first spatial signature based on the first PMI, and the second data stream may have a second spatial signature based on the second PMI. In these embodiments, the receiver module 740 may decouple the first data stream and the second data stream based on the first and second spatial signatures, respectively.

In some embodiments, first transmission rank indicator may have a value of two or greater, and the receiver module 740 may receive a multi-stream transmission from the first base station. For example, the receiver module 740 may receive a third data stream from the first base station, contemporaneously with receiving the first data stream and the second data stream. The third data stream may be different from the first data stream and the second data stream.

In some embodiments, the channel estimation module 720 may determine third feedback information based on channel conditions between the UE 700 and a third base station. The transmitter module 730 may send the third feedback information to the first base station for forwarding to the third base station. Alternatively, the transmitter module 730 may send the third feedback information directly to the third base station. Thereafter, the receiver module 740 may receive a data stream from the third base station contemporaneously with receiving the first data stream and the second data stream. The data stream from the third base station may be different from the first data stream and the second data stream.

FIG. 8 schematically illustrates a base station 800 in accordance with various embodiments. In various embodiments, base station 800 may be equivalent to first base station 102 and/or second base station 106 depicted in FIGS. 1, 4, and 5 and discussed above, or first base station 602, second base station 606 and/or third base station 608 depicted in FIG. 6 and discussed above. Furthermore, base station 800 may be equivalent to one or more of the base stations discussed in relation to UE 700. In various embodiments, the base station 800 may include an eNB, such as a macro eNB, a pico eNB, and/or a femto eNB. Base station 800 may include one or more antennas 810a-d configured to transmit signals to, and/or receive signals from, one or more UEs. In FIG. 8, four antennas are illustrated, although in various other embodiments, any other suitable number of antennas may be included in the base station 800. In various embodiments, the base station 800 may include at least as many antennas as a number of one or more data streams being transmitted by the base station 800, although the scope of the present disclosure may not be limited in this respect. One or more of the antennas 810a-d may be alternately used as transmit or receive antennas. Alternatively, or additionally, one or more of the antennas 810a-d may be dedicated transmit antennas or dedicated receive antennas.

In various embodiments, the base station 800 may further include a processor 820 coupled to the antennas 810a-d and configured to establish a first wireless communication link with a UE over a channel. The base station 800 may further include a receiver module 830 and a transmitter module 840 coupled to the processor 820. The receiver module 830 may receive first feedback information including one or more first feedback indicators associated with the first wireless communication link between the base station 800 and the UE. In some embodiments, the receiver module 830 may also receive second feedback information including one or more second feedback indicators associated with a second wireless communication link between the UE and a second base station. In these embodiments, the transmitter module 840 may send the one or more second feedback indicators to the second base station.

In various embodiments, the first feedback indicators may include a first transmission rank indicator, a first PMI, a first MCS, and/or a first CQI. Similarly, the second feedback indicators may include a second transmission rank indicator, a second PMI, a second MCS, and/or a second CQI.

In various embodiments, the transmitter module 840 may send a first data stream to the UE via the first wireless communication link. The first data stream may have properties based at least in part on one or more of the first feedback indicators. For example, in embodiments where the first feedback indicators include the first PMI, the transmitter module 840 may apply the first PMI to the first data stream so that the first data stream has a first spatial signature.

In various embodiments, the transmitter module 840 may use OFDM to send transmissions to the UE. Accordingly, the first data stream may include one or more first OFDM symbols, with a guard interval between adjacent OFDM symbols. The guard interval may include a cyclic prefix. In various embodiments, the transmitter module 840 may transmit the first OFDM symbols so that the UE starts to receive the first OFDM symbol within a guard interval of a second data stream sent by the second base station. In other embodiments, the transmitter module 840 may transmit the first data stream so that the UE starts to receive a second OFDM symbol of the second data stream within the guard interval of the first data stream.

In some embodiments, the transmitter module 840 may also send another data stream to the UE contemporaneously with the first data stream. The transmitter 840 may send a MIMO transmission including the first data stream and the another data stream.

In some embodiments, the transmitter module 840 may be configured to send MU-MIMO transmissions. In these embodiments, the transmitter module 840 may send another data stream to another UE (i.e., a second UE) contemporaneously with sending the first data stream to the first UE. The another data stream may be sent to the second UE using one or more of the same resource blocks as are used to send the first data stream.

Although certain example methods, apparatus, and articles of manufacture have been described herein, the scope of coverage of the present disclosure is not limited thereto. On the contrary, the present disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

1. A method comprising:
generating, by a user equipment (UE) having a plurality of antennas, first feedback information based on channel conditions of a first channel between the UE and a first evolved NodeB (eNB) of an Internet Protocol (IP) based wireless communication network;
generating, by the UE, second feedback information based on channel conditions of a second channel between the UE and a second eNB of the IP-based wireless communication network;
transmitting, by the UE to the first eNB, the first feedback information;
transmitting, by the UE, the second feedback information to at least one of the first eNB and/or the second eNB;
receiving, by the UE, a first data stream from the first eNB via the first channel; and
receiving, by the UE, contemporaneously with the receiving of the first data stream, a second data stream from the second eNB via the second channel, the second data stream being different from the first data stream.

2. The method of claim 1, wherein the first feedback information includes a transmission rank, a precoding matrix index (PMI), and/or a modulation and coding scheme (MCS) for the first eNB to use when communicating with the UE.

3. The method of claim 2, wherein the transmission rank is a first transmission rank, the PMI is a first PMI, the MCS is a first MCS, and the second feedback information includes a second transmission rank, a second PMI, and/or a second MCS for the second eNB to use when communicating with the UE.

4. The method of claim 3, wherein the first data stream has a first spatial signature based on the first PMI and the second data stream has a second spatial signature based on the second PMI, and wherein the receiving of the first data stream comprises decoupling the first data stream from the second data stream, using the plurality of antennas, and decoding the first data stream, and wherein the receiving of the second data stream comprises decoupling the second data stream from the first data stream, using the plurality of antennas, and decoding the second data stream.

5. The method of claim 1, wherein:
the first data stream includes a first orthogonal frequency division multiplexing (OFDM) symbol and a guard interval;
the second data stream includes a second OFDM symbol, and
the receiving of the second data stream includes starting to receive the second OFDM symbol within the guard interval.

6. The method of claim 1, wherein the first channel and the second channel each include one or more resource blocks, and the first data stream and the second data stream are received via one or more common resource blocks.

7. (canceled)

8. (canceled)

9. The method of claim 1, wherein the first eNB and the second eNB are both associated with a cell of the IP-based wireless communication network, and wherein the first eNB has a higher transmission power than the second eNB.

10. An apparatus to be employed by a user equipment (UE) the apparatus comprising:
a plurality of antennas;
a channel estimation module coupled to the plurality of antennas and configured to determine first feedback information based on channel conditions of a first channel between the UE and a first evolved NodeB (eNB) and second feedback information based on channel conditions of a second channel between the UE and a second eNB, the first feedback information and second feedback information configured to be used by the first eNB and second eNB, respectively, for transmissions to the UE on one or more common resource blocks; and
a transmitter module coupled to the channel estimation module and configured to transmit the first feedback information to the first eNB and to transmit the second feedback information to at least one of the first eNB and/or the second eNB.

11. The apparatus of claim 10, wherein the transmitter module is configured to transmit the first feedback information and the second feedback information to the first eNB.

12. The apparatus of claim 10, wherein the transmitter module is configured to transmit the second feedback information to the second eNB.

13. The apparatus of claim 10, further comprising:
a receiver module coupled to the plurality of antennas and configured to contemporaneously receive a first data stream, including a first orthogonal frequency division multiplexing (OFDM) symbol and a guard interval, from the first eNB, and a second data stream, including a second OFDM symbol and the guard interval, from the second eNB, wherein the second data stream is different from the first data stream and a time difference between when the receiver module starts to receive the first OFDM symbol and when the receiver module starts to receive the second OFDM symbol is less than a time period of the guard interval.

14. The apparatus of claim 13, wherein:
the first feedback information includes a first precoding matrix index (PMI) and the second feedback information includes a second PMI, and the first data stream has a first spatial signature based on the first PMI and the second data stream has a second spatial signature based on the second PMI; and
the receiver module is further configured to decouple the first data stream from the second data stream, using the plurality of antennas, based on the first spatial signature and the second spatial signature.

15. (canceled)

16. The apparatus of claim 13, wherein the first feedback information includes a transmission rank indicator having a value of two or greater, and the receiver module is further configured to receive, contemporaneously with receiving the first data stream, a third data stream from the first eNB, the third data stream being different from the first data stream and the second data stream.

17. The apparatus of claim 13, wherein the channel estimation module is further configured to determine third feedback information based on channel conditions of a third channel between the UE and a third eNB, the transmitter module is further configured to transmit the third feedback information to at least one of the first eNB, the second eNB, and/or the third eNB, and the receiver module is further configured to receive a third data stream from the third eNB on one or more of the common resource blocks.

18. An apparatus to be employed by an evolved NodeB (eNB) the apparatus comprising:
a processor configured to establish a first wireless communication link between the eNB and a user equipment (UE) over a channel;
a receiver module coupled to the processor and configured to receive feedback information related to the channel with respect to wireless communication links between the UE and two or more eNBs, the feedback information including one or more first feedback indicators associated with the first wireless communication link and one or more second feedback indicators associated with a second wireless communication link between the UE and another eNB over the channel; and
a transmitter module coupled to the processor and configured to transmit the one or more second feedback indicators to the other eNB.

19. The apparatus of claim 18, wherein the one or more first feedback indicators include a first transmission rank, a first precoding matrix index (PMI) and/or a first modulation and coding scheme (MCS) for the eNB to use when communicating with the UE, and the one or more second feedback indicators include a second transmission rank, a second PMI, and/or a second MCS for the other eNB to use when communicating with the UE.

20. The apparatus of claim 18, wherein the transmitter module is further configured to transmit, via the first wireless communication link, a first data stream having properties based at least in part on the one or more first feedback indicators, the first data stream being different from a second data stream transmitted by the other eNB to the UE contemporaneously with the transmitting of the first data stream by the eNB.

21. The apparatus of claim 20, wherein the first data stream includes a first orthogonal frequency division multiplexing (OFDM) symbol and the second data stream includes a second OFDM symbol and a guard interval, and wherein the transmitter module is further configured to transmit the first OFDM symbol to the UE so that the first OFDM symbol arrives at the UE during the guard interval of the second data stream.

22. The apparatus of claim 20, wherein the one or more first feedback indicators include a transmission rank having a value of two or greater, and the transmitter module is further configured to transmit, contemporaneously with transmitting the first data stream, a third data stream to the UE, the third data stream being different from the first data stream and the second data stream.

23. The apparatus of claim 18, wherein the UE comprises a first UE, and the transmitter module is further configured to transmit a multi-user multiple input multiple output (MU-MIMO) transmission over the channel, the MU-MIMO transmission including the first data stream configured to be received by the first UE and a third data stream configured to be received by a second UE.

24. An apparatus to be employed by an evolved NodeB (eNB) the apparatus comprising:
a processor configured to establish a wireless communication link with a user equipment (UE) over a channel; and
a transmitter module coupled to the processor and configured to send a first data stream to the UE, the first data stream including a first orthogonal frequency division multiplexing (OFDM) symbol and a guard interval, the transmitter further configured to transmit the first data stream so that a time difference between when the UE starts to receive the first OFDM symbol and when the UE starts to receive a second OFDM symbol sent from another eNB is less than a time period of the guard interval.

25. The apparatus of claim 24, further comprising:
a receiver module coupled to the processor and configured to receive, from the UE via the communication link, first feedback information based on channel conditions between the UE and the eNB and second feedback information based on channel conditions between the UE and the other eNB;
wherein the transmitter module is further configured to send the second feedback information to the other eNB.

26. The apparatus of claim 25, wherein the first feedback information includes a first transmission rank, a first precoding matrix index (PMI) and/or a first modulation and coding scheme (MCS) for the eNB to use when communicating with the UE, and the second feedback information includes a second transmission rank, a second PMI, and/or a second MCS for the other eNB to use when communicating with the UE.

27. The apparatus of claim 25, wherein the first feedback information includes the first PMI and the second feedback information includes the second PMI, and the first data stream has a first spatial signature based on the first PMI and the second data stream has a second spatial signature based on the second PMI, the first spatial signature being different than the first spatial signature.

28. (canceled)

29. The apparatus of claim 24, wherein the UE comprises a first UE, and the transmitter is further configured to transmit a multi-user multiple input multiple output (MU-MIMO) transmission over the channel, the MU-MIMO transmission including the first data stream configured to be received by the first UE and a third data stream configured to be received by a second UE.
